(19) United States
(12) Patent Application Publication
(10) Pub. No.: US 2019/0023096 A1
(43) Pub. Date: Jan. 24, 2019

(54) ESTIMATING LOADS ACTING ON A REAR AXLE OF A MOTOR VEHICLE

(71) Applicant: FORD GLOBAL TECHNOLOGIES, LLC, Dearborn, MI (US)

(72) Inventors: Mina KALDAS, Cologne NRW (DE); Ahmed MOHAMED, Dearborn, MI (US); Thorsten Wilhelm HESTERMEYER, Leverkusen NRW (DE)

(73) Assignee: FORD GLOBAL TECHNOLOGIES, LLC, Dearborn, MI (US)

(21) Appl. No.: 16/024,548

(22) Filed: Jun. 29, 2018

(30) Foreign Application Priority Data
Jul. 18, 2017 (DE) 10 2017 212 225.0

(51) Int. Cl. B60G 17/018; B60G 17/0165

(52) U.S. Cl. CPC B60G 17/0182; B60G 17/0165; B60G 2400/252; B60W 2050/0028; B60G 2500/10; B60G 2600/182; B60G 2500/30

(57) ABSTRACT

The disclosure relates to a method to estimate dynamic loads acting vertically on a rear axle of a motor vehicle during a forward driving operation. To enable an estimation of the dynamic loads acting vertically on the rear axle during the forward driving operation of the motor vehicle cost-effectively, the dynamic loads are estimated in consideration of dynamic mechanical forces engaging vertically at a front axle of the motor vehicle during the forward driving operation. In addition, dynamic acceleration forces engaging at a spring mass of the motor vehicle during the forward driving operation are also considered when estimating the dynamic loads during the forward driving operation.

### CROSS-REFERENCE TO RELATED APPLICATIONS

This application claims foreign priority benefits under 35 U.S.C. § 119(a)-(d) to DE Application 10 2017 212 225.0 filed Jul. 18, 2017, which is hereby incorporated by reference in its entirety.

### TECHNICAL FIELD

The disclosure relates to a method and a continuously controlled damping system that estimate dynamic loads acting vertically on a rear axle of a motor vehicle during a forward travel operation of the motor vehicle.

### BACKGROUND

Equipping a motor vehicle with an active axle suspension and/or active wheel suspension, to be able to influence driving dynamics and driving safety of the motor vehicle in a targeted manner as a function of sensor data of a vehicle sensor system is known. An active wheel suspension can have for this purpose, for example, a continuously controllable and/or adjustable damping system. The damping system comprises a continuously controllable and/or adjustable damping unit for each wheel suspension and an activation unit having activation electronics for individually activating the damping units, to be able to adapt a respective damping force generated by a respective damping unit individually to a respective driving situation.

In addition, a motor vehicle can have two front suspension height sensors, which are each associated with one front wheel suspension and via which an instantaneous spring deflection of a respective front wheel suspension is detectable. The damping system ascertains, on the basis of the signals of these suspension height sensors, damping forces to be generated using the respective damping units and activates individual damping units accordingly. A motor vehicle equipped in this manner typically, additionally requires two rear suspension height sensors associated with rear wheel suspensions, using the sensors a mechanical load acting on the rear axle is ascertainable, which is generated by a spring mass of the motor vehicle. The damping forces ascertained by the damping system have to be adapted in consideration of an ascertained rear axle load to a respective loading state of the motor vehicle, to be able to optimize driving comfort and driving dynamics for various driving situations.

U.S. Pat. No. 8,005,592 B2 relates to a method for controlling a vehicle, wherein a heave motion wheel load is determined, a behavior-based wheel load is determined, a vertical-motion-induced wheel load is determined, a total wheel normal load corresponding to the heave motion wheel load, the behavior-based wheel load, and the vertical-motion-induced wheel load is determined, and a vehicle system is controlled according to the total wheel normal load.

U.S. Pat. No. 6,593,849 B2 relates to a method for determining a wheel heave of a wheel of a motor vehicle, wherein a torque change is exerted on the wheel, a change of a wheel state since beginning a step of exerting a torque change is measured, and a wheel heave is indicated if a change of a wheel state is greater than a predefined value.

U.S. Pat. No. 7,668,645 B2 relates to a method for controlling a safety system for a vehicle, wherein an adaptive roll acceleration coefficient is determined and the safety system is controlled in reaction to the adaptive roll acceleration coefficient.

U.S. Pat. No. 8,112,198 B2 relates to an active suspension system, which has a relatively, slowly responding force pre-tension eliminator (for example, a pneumatic actuator) and a relatively rapidly responding actuator (for example, an electromagnetic actuator), which together assist a facility (such as a utility vehicle seat or a vehicle cab). The system additionally contains a loading-unloading detector (which can be a physical or virtual detector), to detect a loading or unloading of the facility. If such a loading or unloading is established, the system causes the force pre-tension eliminator to react rapidly (for example, as rapidly as possible), while the rapidly responding actuator is controlled to obtain an available energy for actuating the actuator (for example, to prevent the rapidly reacting actuator from consuming all of its available energy), before the force pre-tension eliminator can react.

U.S. Pat. No. 6,684,140 B2 relates to a control system for a motor vehicle having a vehicle body. The control system comprises a first angular velocity sensor, which generates a first angular velocity signal corresponding to a first angular movement of the vehicle body, a suspension height sensor, which generates a suspension height signal corresponding to the suspension height of the vehicle, a lateral acceleration sensor, which generates a lateral acceleration signal corresponding to a lateral acceleration of a vehicle body center of gravity, a longitudinal acceleration sensor, which generates a longitudinal acceleration signal corresponding to the longitudinal acceleration of the vehicle body center of gravity, and a control unit, which is coupled to the first angular velocity sensor, the suspension height sensor, the lateral acceleration sensor, and the longitudinal acceleration sensor. The control unit determines a roll characteristic from the first angular velocity signal, the suspension height signal, and the lateral acceleration signal, and a pitch characteristic from the first angular velocity signal, the suspension height signal, and the longitudinal acceleration signal.

### SUMMARY

One object of the disclosure is to enable an estimation of dynamic loads acting vertically on a rear axle of a motor vehicle during a forward driving operation of the motor vehicle cost-effectively.

Advantageous embodiments are reflected in the following description, and the Figures, wherein these embodiments can each represent a refining, in particular also preferred or advantageous, aspect of the disclosure per se or in various combinations of at least two of these embodiments with one another. Embodiments of the method can correspond to embodiments of the system in this case, and vice versa, even if this is not explicitly noted in the individual case hereafter.

According to a method according to the disclosure that estimates dynamic loads acting vertically on a rear axle of a motor vehicle during a forward driving operation of the motor vehicle, the dynamic loads are estimated in consideration of dynamic mechanical forces engaging vertically at a front axle of the motor vehicle during the forward driving operation, and dynamic acceleration forces engaging at a spring mass of the motor vehicle during the forward driving operation.

According to the disclosure, dynamic loads acting vertically on the rear axle of the motor vehicle during the forward driving operation of the motor vehicle can be estimated without additional rear suspension height sensors associated with the rear wheel suspensions being required for this purpose, as is conventional. Since therefore such suspension height sensors do not have to be installed in the motor vehicle, estimation of dynamic loads acting vertically on the rear axle of the motor vehicle during a forward driving operation of the motor vehicle is possible more cost-effectively using the disclosure.

To estimate the dynamic loads acting vertically on the rear axle of the motor vehicle during a forward driving operation of the motor vehicle, an estimation algorithm can be used, to which the dynamic mechanical forces engaging vertically on a front axle of the motor vehicle during the forward driving operation, and the dynamic acceleration forces engaging on the spring mass of the motor vehicle during the forward driving operation can be supplied unprocessed or processed as input parameters. The estimation algorithm outputs an instantaneous dynamic load acting vertically on the rear axle of the motor vehicle during the forward driving operation of the motor vehicle as an output parameter.

The dynamic loads acting vertically on the rear axle of the motor vehicle are generated by a dynamic weight of the spring mass or a fraction of the dynamic weight of the spring mass of the motor vehicle on the rear axle. The dynamic mechanical forces engaging vertically on the front axle of the motor vehicle arise during the forward driving operation of the motor vehicle due to the fraction of the dynamic weight of the spring mass of the motor vehicle at the front axle and/or forces acting on the front axle and generated by roadway irregularities, which are transferred via front wheels of the motor vehicle to the front axle. The dynamic acceleration forces engaging at the spring mass of the motor vehicle during the forward driving operation arise due to roadway irregularities driven over during the forward driving operation, longitudinal accelerations of the motor vehicle, and/or steering driving movements of the motor vehicle.

If needed, the fraction of the dynamic weight of the spring mass at the rear axle can also be ascertained from the dynamic loads acting vertically on the rear axle of a motor vehicle during a forward driving operation of the motor vehicle.

According to one advantageous embodiment, the dynamic mechanical forces are ascertained in consideration of spring deflections and/or spring velocities detected at each of the wheel suspensions of the front axle. The dynamic mechanical forces engaging at a front axle of the motor vehicle can thus be derived from the spring deflections and/or spring velocities, for example, via the abovementioned estimation algorithm.

A further advantageous embodiment provides that the dynamic acceleration forces are ascertained from sensorially detected vertical movements of the spring mass, roll movements of the spring mass about a vehicle longitudinal axis, and/or pitch movements of the spring mass about a vehicle transverse axis, in particular via the abovementioned estimation algorithm. In this way, the dynamic acceleration forces may be detected three-dimensionally, to have the most precise and extensive items of information possible provided on the actual dynamic acceleration forces.

According to a further advantageous embodiment, dynamic mechanical forces engaging at the rear axle, from which the dynamic loads are ascertained, are estimated in consideration of the dynamic mechanical forces and the dynamic acceleration forces. Accordingly, the dynamic mechanical forces engaging at the rear axle are thus firstly estimated in consideration of the dynamic mechanical forces engaging at the front axle and the dynamic acceleration forces engaging at the spring mass of the motor vehicle. After which the dynamic loads are ascertained from the dynamic mechanical forces engaging at the rear axle. Since the dynamic mechanical forces engaging at the rear axle are estimated and the dynamic loads are ascertained therefrom, the dynamic loads are also estimated according to this embodiment of the disclosure.

A system according to the disclosure that estimates dynamic loads acting vertically on a rear axle of a motor vehicle during a forward driving operation of the motor vehicle comprises at least one analysis electronics system, which is configured to estimate the dynamic loads in consideration of dynamic mechanical forces engaging vertically at a front axle of the motor vehicle during the forward driving operation and dynamic acceleration forces engaging at a spring mass of the motor vehicle during the forward driving operation.

The advantages mentioned above with reference to the method are correspondingly linked to the system. In particular, the system can be used to carry out the method according to one of the abovementioned embodiments or an arbitrary combination of at least two of these embodiments with one another. The analysis electronics system can be designed as a separate modular unit or can be implemented by a software implementation in a conventional vehicle electronics system that is already provided. The analysis electronics system preferably executes an estimation algorithm, to be able to estimate the dynamic loads acting vertically on the rear axle of the motor vehicle during a forward driving operation of the motor vehicle.

According to one advantageous embodiment, the system comprises sensors associated with various wheel suspensions of the front axle, using spring deflections and/or spring velocities of individual wheel suspensions are detectable, wherein the analysis electronics system is configured to ascertain the dynamic mechanical forces in consideration of the detected spring deflections and/or spring velocities. The advantages mentioned above with reference to the corresponding embodiment of the method are correspondingly linked to this embodiment. The sensors can be suspension height sensors, for example. The sensors can be connected in a wireless or wired manner to the analysis electronics system.

According to a further advantageous embodiment, the system comprises a sensor system that detects vertical movements of the spring mass, roll movements of the spring mass about a vehicle longitudinal axis, and/or pitch movements of the spring mass about a vehicle transverse axis, wherein the analysis electronics system is configured to ascertain the dynamic acceleration forces from the detected vertical movements of the spring mass, roll movements of the spring mass about a vehicle longitudinal axis, and/or pitch movements of the spring mass about a vehicle transverse axis. The advantages mentioned above with reference to the corresponding embodiment of the method are correspondingly linked to this embodiment. The sensor system can be at least one inertial measuring unit having a spatial combination of multiple inertial sensors, such as acceleration sensors and rotation rate sensors. The sensor system can be connected in a wireless or wired manner to the analysis electronics system.

A further advantageous embodiment provides that the analysis electronics system is configured to estimate dynamic mechanical forces engaging at the rear axle in consideration of the dynamic mechanical forces and the dynamic acceleration forces, and ascertain the dynamic loads therefrom. The advantages mentioned above with reference to the corresponding embodiment of the method are correspondingly linked to this embodiment.

A motor vehicle according to the disclosure comprises a continuously controlled and/or adjusted damping system and at least one system according to one of the abovementioned embodiments, or an arbitrary combination of at least two of these embodiments with one another, wherein the damping system is configured to consider the dynamic loads estimated using the system in ascertainment of damping forces that dampen the rear axle.

The advantages mentioned above with reference to the method or the system, respectively, are correspondingly linked to the motor vehicle. The motor vehicle can have a front axle and a rear axle having individual wheel suspensions.

The disclosure will be explained by way of example hereafter with reference to the appended Figures on the basis of preferred embodiments, wherein the features mentioned hereafter can represent an advantageous or refining aspect of the disclosure both taken per se and also in different combinations of at least two of these embodiments with one another. In the Figures:

### BRIEF DESCRIPTION OF THE DRAWINGS

FIG. 1 shows a flow chart of an exemplary embodiment of a method according to the disclosure; and

FIG. 2 shows a schematic illustration of an exemplary embodiment of a motor vehicle according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

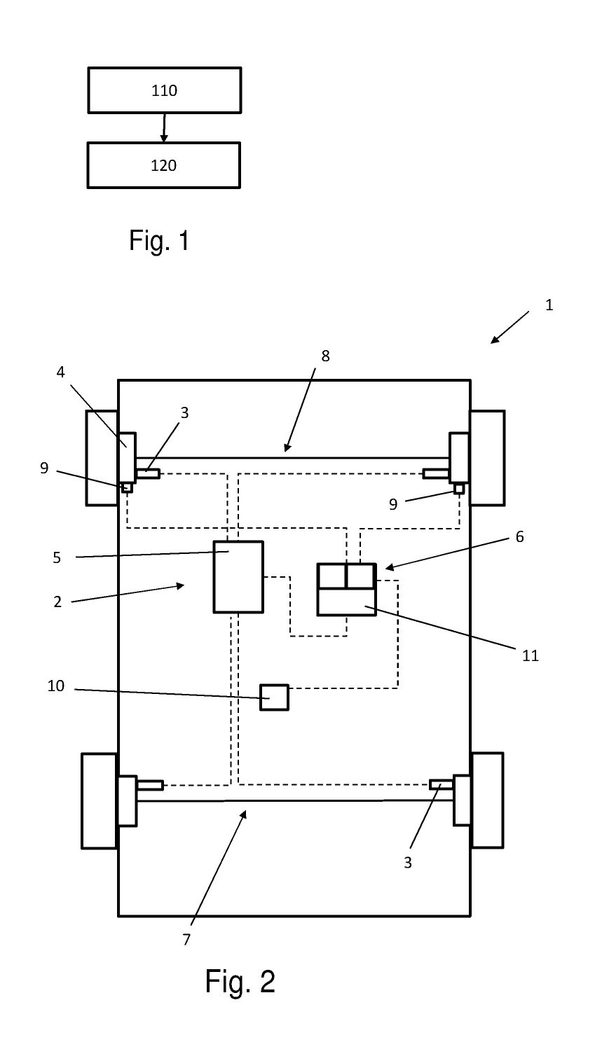

FIG. 1 shows a flow chart of an exemplary embodiment of a method according to the disclosure that estimates dynamic loads acting vertically on a rear axle of a motor vehicle during a forward driving operation of the motor vehicle.

In method step 110, dynamic mechanical forces engaging at a front axle of the motor vehicle during the forward driving operation of the motor vehicle are ascertained in consideration of respective spring deflections and/or spring velocities detected at wheel suspensions of the front axle. At the same time, dynamic acceleration forces engaging at a spring mass of the motor vehicle during the forward driving operation of the motor vehicle are ascertained from sensorially detected vertical movements of the spring mass, roll movements of the spring mass about a vehicle longitudinal axis, and/or pitch movements of the spring mass about a vehicle transverse axis.

In method step 120, the dynamic loads acting vertically on the rear axle of the motor vehicle are estimated in consideration of the dynamic mechanical forces ascertained in method step 110 and the dynamic acceleration forces ascertained in method step 110. It can be provided in this case that, firstly, dynamic mechanical forces engaging at the rear axle are estimated in consideration of the dynamic mechanical forces ascertained in method step 110 and the dynamic acceleration forces ascertained in method step 110, from which subsequently the dynamic loads are ascertained. Alternatively, the dynamic loads can be estimated directly from the dynamic mechanical forces ascertained in method step 110 and the dynamic acceleration forces ascertained in method step 110. Method step 120 is carried out via an algorithm executed by an analysis electronics system of the motor vehicle.

FIG. 2 shows a schematic illustration of an exemplary embodiment of a motor vehicle 1 according to the disclosure.

The motor vehicle 1 comprises a continuously controlled and/or adjusted damping system 2, which can be constructed conventionally, because of which a more precise description of the damping system 2 will be omitted. Using the damping system 2, a respective damping force generated by damping units 3 of the damping system 2 can be adapted individually to a respective driving situation, wherein the damping units 3 are associated with individual wheel suspensions 4 of the motor vehicle 1. The damping units 3 are activated via an activation unit 5 of the damping system 2. The activation unit 5 may be a microprocessor, or controller, as is known in the art.

The motor vehicle 1 moreover comprises a system 6 that estimates dynamic loads acting vertically on a rear axle 7 of the motor vehicle 1 during a forward driving operation of the motor vehicle 1.

The system 6 comprises sensors 9 associated with various individual wheel suspensions 4 of a front axle 8, using which spring deflections and/or spring velocities of the single, individual wheel suspensions 4 are detectable. Furthermore, the system 6 comprises a sensor system 10 in the form of an inertial measuring unit that detects vertical movements of a spring mass of the motor vehicle 1, roll movements of the spring mass about a vehicle longitudinal axis, and/or pitch movements of the spring mass about a vehicle transverse axis.

The system 6 furthermore comprises an analysis electronics system 11, which is connected to the damping system 2, the sensors 9, and the sensor system 10, and can moreover receive and process CAN bus signals of the motor vehicle 1.

The analysis electronics system 11 is configured to ascertain dynamic mechanical forces engaging vertically at the front axle 8 of the motor vehicle 1 during the forward driving operation in consideration of respective spring deflections and/or spring velocities detected at individual wheel suspensions 4 of the front axle 8 using the sensors 9. Furthermore, the analysis electronics system 11 is configured to ascertain dynamic acceleration forces engaging at the spring mass of the motor vehicle 1 during the forward driving operation from vertical movements of the spring mass, roll movements of the spring mass about a vehicle longitudinal axis, and/or pitch movements of the spring mass about a vehicle transverse axis detected via the sensor system 10. For this purpose, the analysis electronics system 11 can be configured to ascertain both an acceleration state at a center of gravity of the spring mass of the motor vehicle 1 and also at four corners of the motor vehicle 1.

The analysis electronics system 11 is configured to estimate the dynamic loads acting vertically on the rear axle 7 of the motor vehicle 1 in consideration of the dynamic mechanical forces engaging vertically at the front axle 8 of the motor vehicle 1 during the forward driving operation, which have been ascertained by the analysis electronics system 11, and the dynamic acceleration forces engaging at the spring mass of the motor vehicle 1 during the forward driving operation, which have been ascertained by the analysis electronics system 11. For this purpose, the analysis electronics system 11 can be configured to estimate dynamic mechanical forces engaging at the front axle 8 in consideration of the dynamic mechanical forces and the dynamic acceleration forces, and subsequently ascertain the dynamic loads therefrom.

The damping system 2 is configured to consider the dynamic loads estimated using the system 6 in the ascertainment of damping forces to dampen the rear axle 7.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method to dampen a vehicle suspension comprising:
using dynamic mechanical forces that engage vertically at a front axle and dynamic acceleration forces that engage at a spring mass during a forward driving operation of a vehicle to estimate dynamic loads acting vertically on a rear axle; and
dampening, via a continuously controlled and adjusted damping system, the rear axle.

2. The method as claimed in claim 1 further comprising detecting spring deflections and spring velocities at each of wheel suspensions of the front axle to ascertain the dynamic mechanical forces.

3. The method as claimed in claim 1 further comprising detecting, sensorially, vertical movements of the spring mass, roll movements of the spring mass about a vehicle longitudinal axis, and pitch movements of the spring mass about a vehicle transverse axis to ascertain the dynamic acceleration forces.

4. The method as claimed in claim 1 further comprising estimating the dynamic mechanical forces that engage at the front axle from the dynamic loads via the dynamic mechanical forces and the dynamic acceleration forces.

5. The method as claimed in claim 4 further comprising dampening, via the continuously controlled and adjusted damping system, the dynamic mechanical forces.

6. A vehicle damping system comprising:
an electronic system configured to, during a forward driving operation of a vehicle, dampen a rear axle based on an estimation of dynamic loads from dynamic mechanical forces engaging vertically at a front axle of the vehicle and dynamic acceleration forces engaging at a spring mass of the vehicle.

7. The vehicle damping system as claimed in claim 6 further comprising sensors associated with various wheel suspensions of the front axle that detect spring deflections and spring velocities of each individual wheel suspension, wherein the electronic system is configured to ascertain the dynamic mechanical forces based on detected spring deflections and spring velocities.

8. The vehicle damping system as claimed in claim 6 further comprising a sensor system that detects vertical movements of the spring mass, roll movements of the spring mass about a vehicle longitudinal axis, and pitch movements of the spring mass about a vehicle transverse axis, wherein the electronic system is configured to ascertain the dynamic acceleration forces from detected vertical movements of the spring mass, roll movements of the spring mass about a vehicle longitudinal axis, and pitch movements of the spring mass about a vehicle transverse axis.

9. The vehicle damping system as claimed in claim 6, wherein the electronic system is configured to estimate dynamic mechanical forces engaging at the rear axle based on the dynamic mechanical forces and the dynamic acceleration forces, and calculate the dynamic loads therefrom.

10. The vehicle damping system as claimed in claim 9, wherein the electronic system is configured to dampen the dynamic mechanical forces.

11. A vehicle comprising:
a damping system configured to, during a forward driving operation of the motor vehicle, dampen a rear axle based on an estimation of dynamic loads from dynamic mechanical forces engaging vertically at a front axle of the motor vehicle and dynamic acceleration forces engaging at a spring mass of the motor vehicle.

12. The vehicle as claimed in claim 11 further comprising sensors associated with various wheel suspensions of the front axle that detect spring deflections and spring velocities of each individual wheel suspension, wherein the damping system is configured to ascertain the dynamic mechanical forces based on detected spring deflections and spring velocities.

13. The vehicle as claimed in claim 11 further comprising a sensor system that detects vertical movements of the spring mass, roll movements of the spring mass about a vehicle longitudinal axis, and pitch movements of the spring mass about a vehicle transverse axis, wherein the electronic system is configured to ascertain the dynamic acceleration forces from detected vertical movements of the spring mass, roll movements of the spring mass about a vehicle longitudinal axis, and pitch movements of the spring mass about a vehicle transverse axis.

14. The vehicle as claimed in claim 11, wherein the damping system is configured to estimate dynamic mechanical forces engaging at the rear axle based on the dynamic mechanical forces and the dynamic acceleration forces, and calculate the dynamic loads therefrom.

15. The vehicle as claimed in claim 14, wherein the damping system is configured to dampen the dynamic mechanical forces.
